(19) United States
(12) Patent Application Publication
(10) Pub. No.: US 2008/0098965 A1
(43) Pub. Date: May 1, 2008

(54) Tangle-free leash/collar system

(76) Inventor: Garo Hachigian, San Diego, CA (US)

Correspondence Address: Klaus P. Stoffel;Wolff & Samson PC, One Boland Drive, West Orange, NJ, 07052, US

(21) Appl. No.: 11/590,270

(22) Filed: Oct. 31, 2006

(51) Int. Cl. A01K 27/00

(52) U.S. Cl. 119/792

(57) ABSTRACT

A leash/collar system including a handle, a collar and a semi-rigid elongate member having a longitudinal axis and connected between the handle and the collar so as to be rotatable along the longitudinal axis.

### BACKGROUND OF THE INVENTION

The present invention relates to a leash and collar system used for walking and controlling an animal.

Normally, leashes are made of a length of cord or line attached to a collar around the animals neck. The cord is usually attached to the collar by some type of a clip. Normally, a spring type clip is used. This type of construction was satisfactory for controlling the animal but often interfered with the movement of the animal due to the animal stepping over the slack in the leash and becoming tangled. Subsequently, self-retracting leashes were developed to automatically adjust the length of the leash. This improvement reduced the likelihood of the animal becoming tangled in the leash, but also reduced the control the handler had over the animal. Furthermore, these retractable leashes were still attached to the collar by a clip.

Thus, there remains need for a leash/collar combination which alleviates the problem of tangling found with prior art leashes.

### SUMMARY OF THE INVENTION

Accordingly, it is an object of the present invention to provide a leash/collar combination that does not tangle or interfere with the movement of the animal wearing the collar.

Pursuant to this object, and others which will become apparent hereafter, one aspect of the present invention resides in a leash/collar system including a handle, a collar and a semi-rigid elongate member having a longitudinal axis and connected between the handle and the collar so as to be rotatable along the longitudinal axis.

In another embodiment of the invention the elongate member is a polyurethane cord.

In a further embodiment swivel connectors are provided to connect the elongate member to the handle and to the collar. The swivel connectors include a first connector having a first receiver attached to an end of the elongate member and a first swivel member having one end attached to the handle and another end attached to the first receiver. The swivel connectors further include a second connector having a second receiver attached to another end of the elongate member and a second swivel member having one end attached to the collar and another end attached to a second receiver.

In still another embodiment a swivel housing is provided which has a recess. The swivel housing is attached to the collar so that a longitudinal axis of the recess is substantially perpendicular to an outer surface of the collar. The one end of the second swivel member is attached in the recess of the swivel housing.

In yet another embodiment the swivel members are barrel swivel members.

Still a further embodiment has the collar as a nylon strap. The swivel housing is stitched to the nylon strap.

A further embodiment provides the handle is a nylon strap. A “D” ring can be fixed to one end of the strap and the other end of the strap can pass through the “D” ring to form an adjustable loop. The strap has a hole there through and a nylon cord is connected to the one end of the first swivel member, passes through the hole in the strap and is fixed to a surface of the strap on an interior side of the loop.

In another embodiment the elongate member is attached to the collar so that when the collar is on an animal the elongate member extends from a portion of the collar at the top of the animal's neck.

Other features and advantages of the present invention will become apparent from the following description of the invention that refers to the accompanying drawings.

### BRIEF DESCRIPTION OF THE DRAWINGS

FIG. 1 is a schematic view of the invention in use;

FIG. 2 is an exploded perspective view of the invention; and

FIG. 3 is a detailed view of the leash/collar combination.

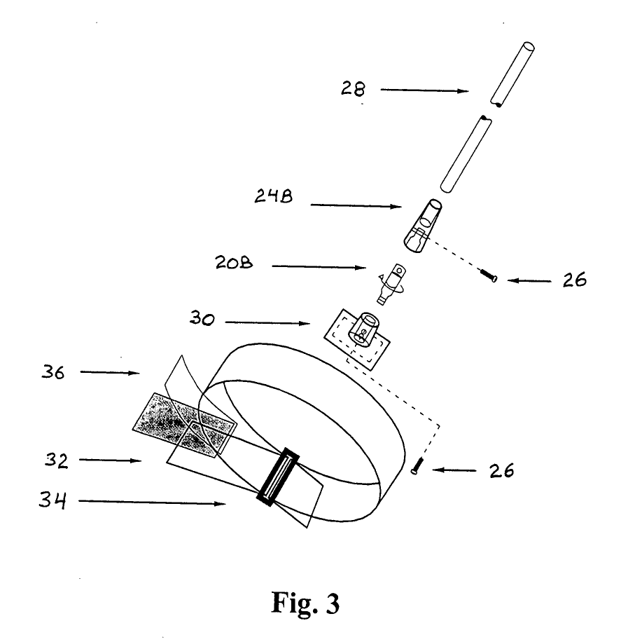

### DETAILED DESCRIPTION OF THE INVENTION

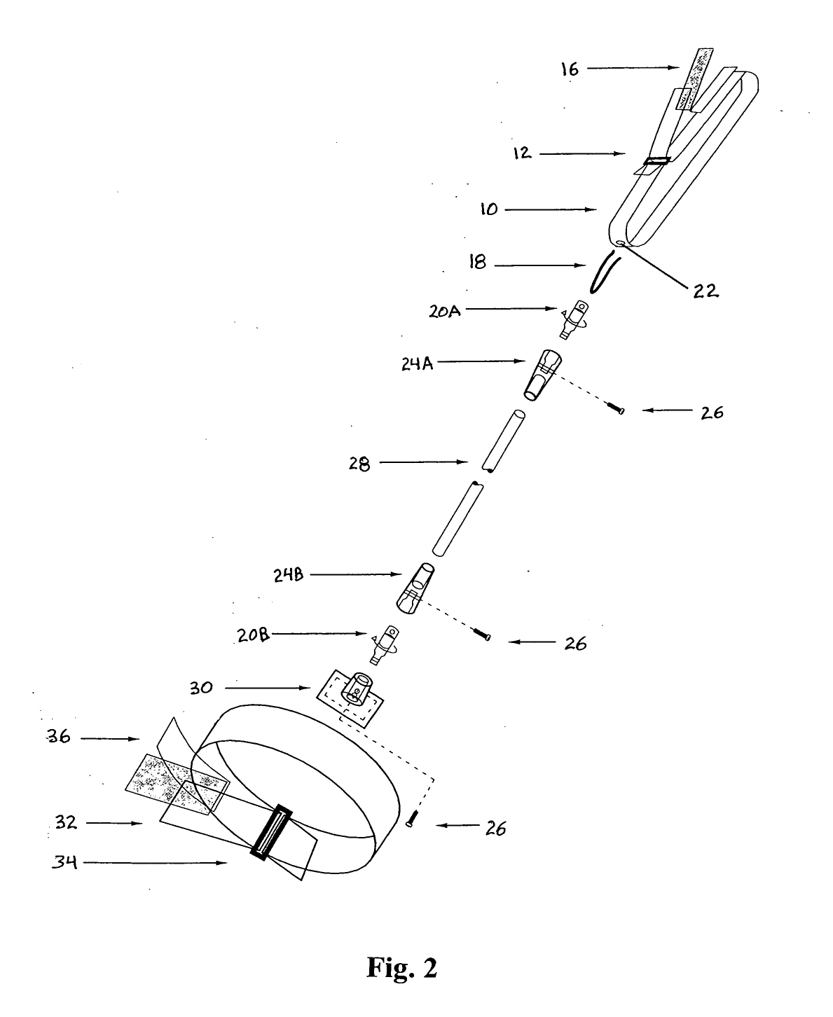

As shown in the exploded view of FIG. 2, the inventive system, in one embodiment, has a handle 10 made of a length of nylon strapping with a “D” ring 12 stitched to one end of the strapping and the other end of the strapping 10 passing through the ring 12 to form a loop. The free end of the strapping 10 and a corresponding outer surface of the loop are provided with hook and loop fasteners 16 whereby the size of the loop is adjustable and can be maintained.

A cord 18, such as a nylon cord, passes through an opening in the end of a first heavy-duty brass barrel swivel 20A. The ends of the cord 18 pass through a hole 22 in the handle 10 and are fixed to the interior of the handle, for example by stitching. This, of course, is only one possible way of attaching the first swivel 20A to the handle 10. Other types of connections are considered to fall within the scope of the present invention.

The other end of the first swivel 20A is inserted into a first swivel housing/cord receiver 24A and secured in place by a set screw 26 that passes through the first swivel housing 24A and the first swivel 20A.

One end of a length of round polyurethane cord 28 is inserted into the first swivel housing/cord receiver 24A and is fixed in place, for example by gluing. The other end of the polyurethane cord 28 is inserted in the same manner to a second housing/receiver 24 B.

A second barrel swivel 20B is inserted into the second housing/receiver 24B and secured with a setscrew 26. The other end of the second swivel 20B is inserted in a recess of a swivel housing 30 and is secured there by a setscrew 26. The swivel housing 30 is fixed to the collar 32 by, for example, stitching. The collar 32 is formed by nylon strapping in a manner similar to the handle 10. A D-ring 34 is attached to one end of the strapping and the other end of the strapping passes through the D-ring 34 to form a loop. The free end of the strapping is attached to the outer surface of the strapping by hook and loop fasteners 36. In this way, the collar can be adjusted to the appropriate size of the neck of the animal on which it is used.

Next will be described the operation of the leash/collar system. Firstly, the collar 32 is placed around the animal's neck and the individual walking the animal holds the handle 10 for purposes of controlling the animal, as with conventional leashes and collars. The unique construction of the present invention controls the animal while at the same time prevents the animal from stepping over the leash by walking and thereby avoids entanglement. The first barrel swivel 20A serves to keep the leash and handle assembly from twisting and tangling by swiveling to correct any twist that might occur while the leash is in operation. The first housing/cord receiver 24A connects the round polyurethane cord 28 to the first heavy barrel swivel 20A and thus to the handle assembly. The round polyurethane cord maintains the correct distance to the animal, connects one end of the leash to the other, and prevents tangling due to the inherent modest or semi-rigidity of the polyurethane cord. The polyurethane cord also has very low memory which together with the rigidity makes it difficult to knot the cord. The second swivel housing/cord receiver 24B functions similarly to the first receiver 24A but on the other end of the polyurethane cord 28. The second barrel swivel 20B prevents the leash from being twisted or tangled by swiveling to compensate for the movement of the animal.

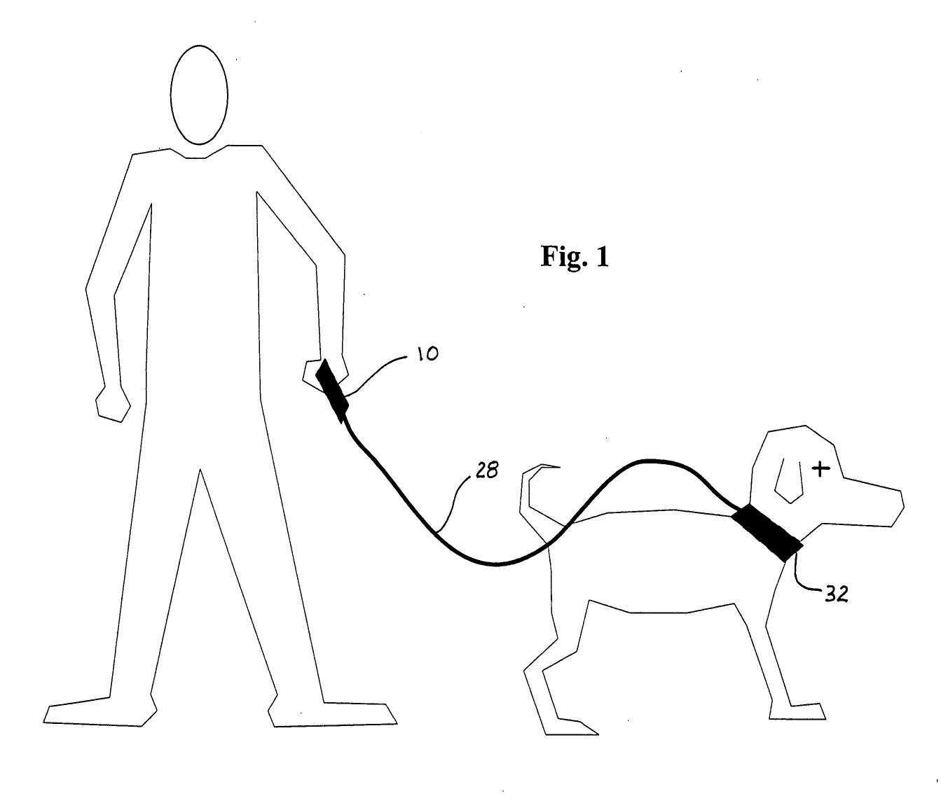

The swivel housing 30 that is attached to the collar 32 extends substantially perpendicularly from the collar and serves to keep the second swivel 20B, the second housing/cord receiver 24B and the polyurethane cord 28 at a right angle to the surface of the collar. The swivel housing 30 is positioned on the top of the animal's neck so that the polyurethane cord protrudes upwardly from the neck of the animal as shown in FIG. 1. This serves to prevent the animal from stepping on the polyurethane cord 28 and keeps the leash off of the animal.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A leash/collar system, comprising:
a handle;
a collar; and
a semi-rigid elongate member having a longitudinal axis and connected between the handle and the collar so as to be rotatable along the longitudinal axis.

2. The leash/collar system according to claim 1, wherein the elongate member is a polyurethane cord.

3. The leash/collar system according to claim 1, and further comprising swivel connectors arranged to connect the elongate member to the handle and to the collar.

4. The leash/collar system according to claim 3, wherein the swivel connectors include a first connector having a first receiver attached to an end of the elongate member and a first swivel member having one end attached to the handle and another end attached to the first receiver.

5. The leash/collar system according to claim 4, wherein the swivel connectors include a second connector having a second receiver attached to another end of the elongate member and a second swivel member having one end attached to the collar and another end attached to a second receiver.

6. The leash/collar system according to claim 5, and further comprising a swivel housing having a recess, the swivel housing being attached to the collar so that a longitudinal access of the recess is substantially perpendicular to an outer surface of the collar, the one end of the second swivel member being attached in the recess of the swivel housing.

7. The leash/collar system according to claim 5, wherein the swivel members are barrel swivel members.

9. The leash/collar system according to claim 6, wherein the collar is a nylon strap.

10. The leash/collar system according to claim 9, wherein the swivel housing is stitched to the nylon strap.

11. The leash/collar system according to claim 6. wherein the handle is a nylon strap.

12. The leash/collar system according to claim 11, wherein a “D” ring is fixed to one end of the strap and the other end of the strap passes through the “D” ring to form an adjustable loop, the strap having a hole therethrough, a nylon cord being connected to the one end of the first swivel member, passing through the hole in the strap and being fixed to a surface of the strap on an interior side of the loop.

13. The leash/collar system according to claim 1, wherein the elongate member is attach to the collar so that when the collar is on an animal the elongate member extends from a portion of the collar at the top of the animal's neck.

14. The leash/collar system according to claim 10, wherein a “D” ring is fixed to one end of the strap and the other end of the strap passes through the “D” ring to form an adjustable loop.

15. The leash/collar system according to claim 12, wherein hook and loop fasteners are attached to a region of the strap near the other end of the strap and to a corresponding surface of the strap so that when the other end of the strap passes through the “D” ring the hook and loop fasteners can be attached together to maintain a size of the loop formed by the strap.

16. The leash/collar system according to claim 14, wherein hook and loop fasteners are attached to a region of the strap near the other end of the strap and to a corresponding surface of the strap so that when the other end of the strap passes through the “D” ring the hook and loop fasteners can be attached together to maintain a size of the loop formed by the strap.

17. The leash/collar system according to claim 7, wherein the elongate member is glued to the first and second receivers.

18. The leash/collar system according to claim 2, wherein the cord has a round cross section.
